(19) United States
(12) Patent Application Publication
(10) Pub. No.: US 2014/0258307 A1
(43) Pub. Date: Sep. 11, 2014

(54) Method for Preparing Numerous Data for Efficient Manipulation using Interning

(71) Applicants: NICHOLAS W. WEST, REDMOND, WA (US); ADAM K. GOETSCH, SAMMAMISH, WA (US)

(72) Inventors: NICHOLAS W. WEST, REDMOND, WA (US); ADAM K. GOETSCH, SAMMAMISH, WA (US)

(21) Appl. No.: 13/791,281

(22) Filed: Mar. 8, 2013

(51) Int. Cl. G06F 17/30

(52) U.S. Cl. CPC G06F 17/30551
USPC 707/746; 707/721

(57) ABSTRACT

A data-processing technique for increasing data-size capacity and improving query speed on large datasets where fields within records are replaced by integers representing distinct values of those fields, the integers drawn from a densely-populated range so that record selection, aggregation and other actions can be performed efficiently using bit sets and other data structures.

### CONTINUITY AND CLAIM OF PRIORITY

This is an original U.S. patent application.

### FIELD

The invention relates to preparing data for information retrieval. More specifically, the invention relates to methods for transforming data structures and data objects with the purpose of facilitating further processing thereof.

### BACKGROUND

The relentless advances in computing power and storage capacity whose underpinnings are recognized as conforming to Moore's Law ensures that ever more data (both kinds and quantities) are being collected and made available for analysis. Hardware and software improvements raise the practical limits on data set sizes that can be examined and manipulated, but there is still a large and growing gap between “big data” and “interactively explorable data.” That is, while it is possible to execute queries and compute aggregate values over petabytes of data, the queries often take hours or even clays to run—one can obtain answers, but they are only useful if one knows the right questions before beginning. For exploring and investigating datasets—for learning the right questions to ask—faster query turnaround is essential.

Techniques for improving query performance on “medium-sized” datasets can increase the set sizes that can be explored interactively, reduce the hardware requirements for conducting data investigations, and/or answer more-complicated questions quickly. Such techniques may be of significant value in this field.

### SUMMARY

Embodiments of the invention translate fields of data records into contiguous, fully-populated integer ranges. These integer stand-ins for the original data are often smaller in size than the original data, and can usually be manipulated faster. Thus, the translation permits faster query execution, and the queries can operate over larger data set sizes.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining basic operations according to an embodiment of the invention.

FIGS. 2A and 2B comprise a more detailed flow chart of an embodiment.

FIG. 3 shows how a dataset can be queried.

FIG. 4 illustrates another way of viewing the result of an embodiment's operation.

### DETAILED DESCRIPTION

Embodiments of the invention form part of a suite of data management and processing techniques that expand the envelope of data quantities and analyses that can be performed interactively. Real-time exploration of vast data sets is a powerful tool that can help managers of systems that collect data about their operations, identify, characterize and understand nuances of the systems. Improved understanding, in turn, can help inform changes to optimize the system.

Embodiments can be used to process many different sorts of data. However, it is helpful to have a specific dataset in mind when describing the methods. Therefore, most of the following material will focus on records that might be collected during the operation of a web server:

TABLE 1

| #Timestamp | VisitorId | IpAddress | ArticleTitle |
|---|---|---|---|
| 2012-04-21 21:11:48.00 | 6791015 | 1.1.171.10 | ft.com/arts &amp; leisure |
| 2012-04-18 16:56:35.00 | 7228408 | 1.112.8.233 | comment opinion, analysis, letters |
| | | | and editorial comment from the |
| | | | financial times - ft.com |
| 2012-04-19 18:03:31.00 | 7810819 | 1.1.189.72 | comment opinion, analysis, letters |
| | | | and editorial comment from the |
| | | | financial times - ft.com |
| 2012-04-16 06:19:17.00 | 6947423 | 1.1.168.123 | comment opinion, analysis, letters |
| | | | and editorial comment from the |
| | | | financial times - ft.com |
| 2012-04-15 11:37:45.00 | 567524 | 1.140.224.39 | world business, finance, and |
| | | | political news from the financial |
| | | | times -ft.com uk |
| 2012-04-15 16:14:45.00 | 7245320 | 108.132.59.187 | The west has lost in Afghanistan |
| 2012-04-18 11:56:33.00 | 7361691 | 1.138.182.27 | world business, finance and political |
| | | | news from the financial times - ft.com |
| | | | asia |
| 2012-04-16 19:53:11.00 | 7518724 | 109.100.201.150 | ft.com/ |
| | | | search#topicsmoreanchor#topicsmoreanchor |
| 2012-04-19 04:32:48.00 | 2467978 | 109.11.132.54 | world business, finance, and |
| | | | political news from the financial |
| | | | times - ft.com. |

Each record includes a timestamp, a visitor identification number, an Internet Protocol (“IP”) address from which the visitor accessed the resource, and a text string (“ArticleTitle”) that identifies the resource accessed at that time. It is appreciated that web servers often collect many more types of information about their visitors, but the simple dataset shown here is sufficient to illustrate important aspects of an embodiment's operation.

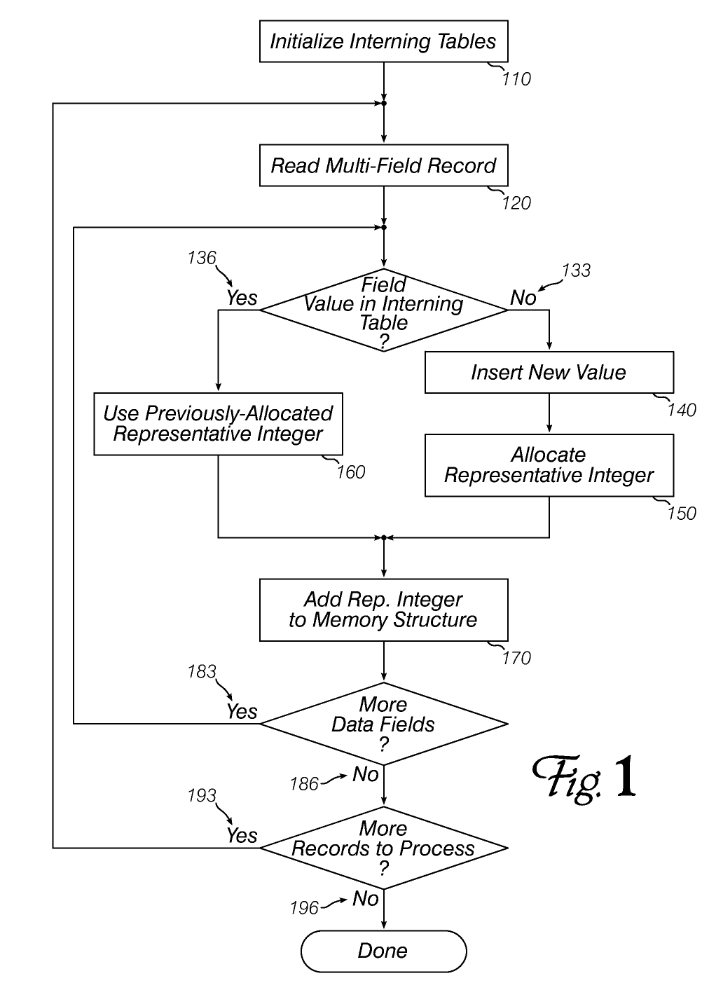

With this sample dataset in mind, we turn to the flow chart of FIG. 1. First, data interning tables are initialized (110). Next, one of the multi-field data records is read from the dataset (120). The fields are separated, and for each field, the appropriate interning table (one table for each field) is searched. If the field value is not present in the table (133), the new value is added (140) and a representative integer is allocated (150). Thenceforth, the representative integer corresponds to the field value in operations of an embodiment. For example, given the data shown in Table 1, VisitorId 6791015 might be assigned representative integer 1, and VisitorId 7228408 might be assigned representative integer 2. Representative integers are assigned to distinct field values on a per-field basis, so the integer 1 for the IpAddress field might correspond to IP address 1.1.171.10, and 2 might correspond to 1.112.8.233.

While reading the dataset, if a field value is already found in the appropriate interning table (136), then the previously-allocated representative integer is used (160). These integers (either new or previously-allocated) are placed in a memory structure created to represent the multi-field record being processed (170). If there are more data fields in the record (183), their values are interned similarly into other tables. Once all the data fields have been interned (186), the next record (if any) is processed (193). And after all the multi-field records have been processed (196), the interned tables are ready for use in searching and querying.

The foregoing method results in the creation of a number of useful data structures, which are typically kept in random-access memory (“RAM”) for fast and flexible manipulation. First, there are interned-value tables with entries for each distinct value of a data field that was encountered during the importing process. Each such entry comprises the field value and an integer that represents the value. And second, there are many memory records, each representing one of the multi-field records. In these memory records, some or all field values have been replaced by a representative integer from the corresponding interned-value table. Representative integers are densely allocated—that is, each integer value from a minimum (such as zero) to a maximum (e.g., one less than the number of distinct values detected in that field, in that data set) corresponds to a particular data value. In some embodiments, a few extra integers may be allocated and assigned administrative meanings. For example, zero (0) might be used to indicate “no value present,” or one (1) might mean “invalid field data in record.” However, in an embodiment, substantially all integers between a minimum and maximum value will represent one distinct value of a data field.

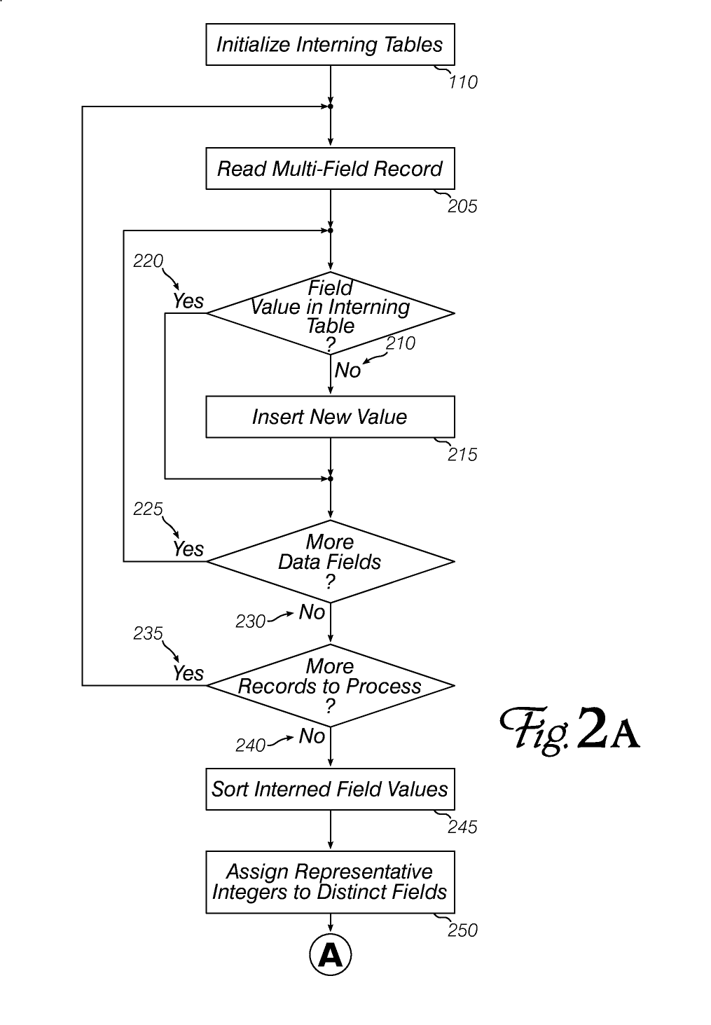

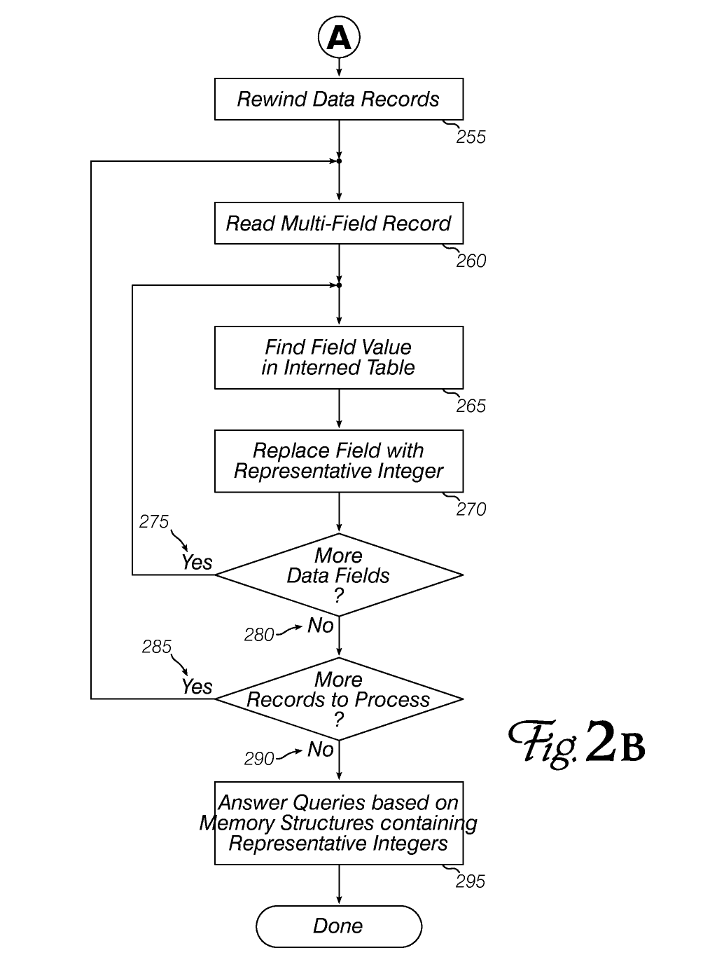

For some field types, an enhanced interning process can create more useful data structures. This enhanced process is outlined in FIGS. 2A and 2B. As before, the interning tables are initialized (110), and then the system begins reading multi-field records of the dataset (205). If a field's value is missing from the interning table (210), it is inserted; otherwise (220), processing continues with other fields from the record, if any (225). When all the fields of a record have been processed (230), if there are more records to process (235) then the next record is read in (205). When there are no more records to read (240), each interned-data table is sorted (245) and then representative integers are assigned (250). This ensures that, for each field, the representative integers are in the same numerical order as the sorted distinct field values. Again, some “administrative” integers may be present, but most integers in an interned data table represent a value seen in at least one of the multi-field records of the data set.

Next (in FIG. 2B), the dataset is rewound (255) so that the records can be read a second time. In this pass, for each multi-field record (260), and for each field of the record, the field value is located in the appropriate interned table (265) and the corresponding representative integer is stored in a memory record (270). This process is repeated for each field of a record (275), and for each of the multi-field records (285). When all of the records have been processed (290), the memory structures can be used to answer users' queries about the dataset (295).

It is appreciated that making two passes through a large dataset may take twice as long as a single pass, but the benefits of having representative integers whose numerical order corresponds to a known sorting order of the original field data may outweigh the time cost of making the second pass. It should be recognized that sorting is not useful for every possible field type. Thus, some systems may be able to improve dataset loading times by allocating some representative integers on a first pass (for fields that need not be sorted) and allocating sorted representative integers only for the remaining fields on the second pass.

Useful sorting criteria for data fields include temporal, for timestamps and date fields; alphabetic for text fields; and numeric for quantitative fields. (The sample dataset described above does not have any quantitative fields, but an example of such a field that might be present in a web server log is a response-size field—the number of bytes of data transmitted to the client in response to the client's request.) In some embodiments, a record may have information indicating a price, cost, revenue or similar economic quantity. Sorting on the basis of such a field may be useful for identifying records that have a large (or small) financial impact on the system from which the data records were collected.

Conceptually, the interning process is somewhat like data compression, since a number of distinct field values (of arbitrary length) end up represented by integers from a densely-populated range. Even where the original data field values are of the same length as the integers that represent the values, there is still a useful compression-like effect. For example, four-byte IP addresses in a dataset may end up represented by four-byte integers, but the representative integers will all be less than some maximum value (near or equal to the number of distinct IP addresses found in the dataset) whereas the IP addresses themselves are likely to be dispersed widely across the four-byte range from 0 to 2³²−1 (0.0.0.0 to 255.255.255.255) and to have large unused gaps between adjacent addresses. By mapping arbitrary field values to sequences of integers, embodiments can use data structures such as bit vectors to perform searching, counting and correlating operations efficiently over very large data sets.

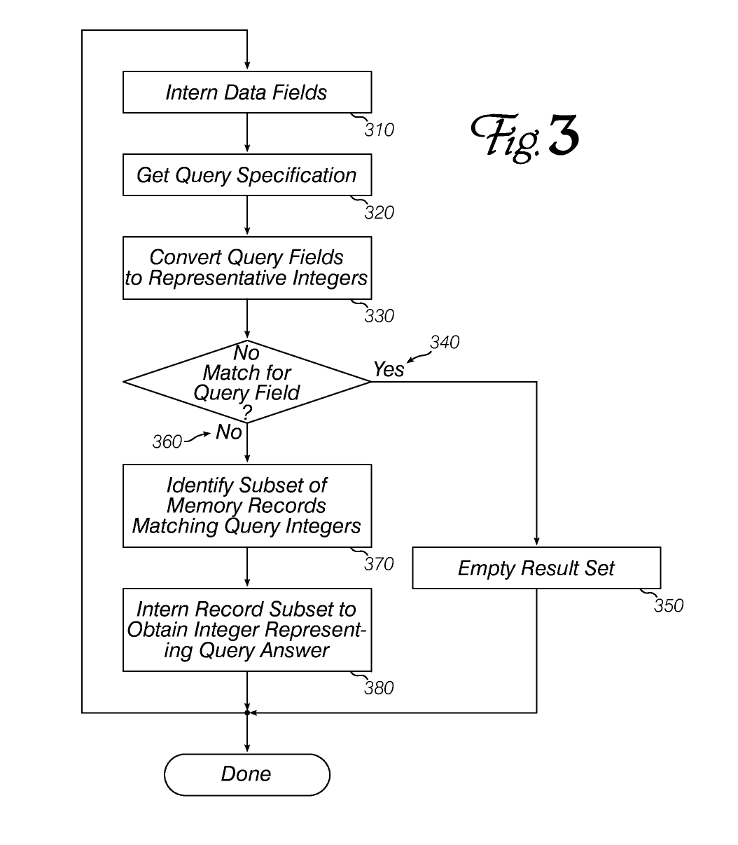

FIG. 3 outlines a method by which the interned data tables can be put into service answering queries about the dataset. Embodiments are particularly useful for finding exact answers to “counting” and “aggregating”-type queries (for example, with the simple dataset described above, “how many different users accessed documents between Tuesday evening and Thursday morning, Greenwich Mean Time?” Or “which were the most-accessed resources, and which of the users who accessed those resources, also accessed the largest number of other resources during the time represented by the dataset?”) Prior-art approaches to answering these types of queries can provide approximate results for large datasets in comparable time, but exact results for large datasets take significantly longer to compute. The inventors have learned that query results that only approximate correct values tend to erode user confidence in a system, even when the dataset is so large that the differences between the estimates and the true value are of no practical significance. Thus, accuracy is not merely an abstract goal to strive for; it is a valuable feature of a system and a competitive differentiator.

Once the fields and records of a dataset have been interned (310), an embodiment accepts a query specification (320) as individual field values, value ranges, or functions thereof. Query specifications may include, for example, typical Structured Query Language (“SQL”) constructs such as “COUNT,” “COUNT DISTINCT,” “UNION,” “GROUP BY,” “ORDER BY” and the like. Field values (and value ranges) are converted to representative integers by looking them up in the interned data tables (330). If a query field has no match in the appropriate interned data table (340), the query process can be short-circuited because it is known that no matching data exists in the dataset (350). Otherwise (360) the embodiment identifies the subset of memory records that match the query's representative integers (370). In some embodiments, the resulting subset can be treated as another data field value and interned in a table representing query result subsets (380). Additional queries may be submitted against the interned dataset. Indeed, embodiments that amortize the computational effort of creating the interned-data tables by answering many queries about the same dataset are particularly valuable. And by interning (effectively, caching) prior query results, later queries can run even faster when query-planning logic determines that the result of an earlier query (or the union of two or more earlier query results) identifies a subset of the complete dataset whose search is sufficient to answer the new query.

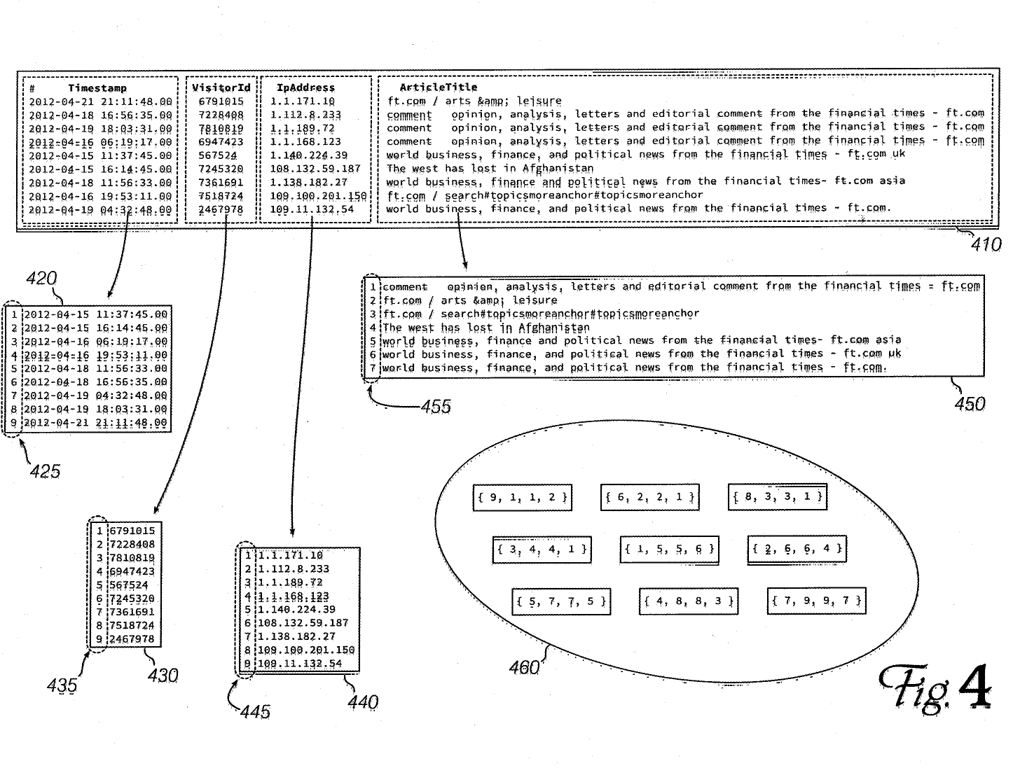

FIG. 4 shows another way of thinking about the interning process. The sample dataset described above (410) is separated into a plurality of arrays (420-450). Each array is the interned data table for the corresponding field of each record, and the index of an entry in an array (425-455) is the representative integer used in the in-memory data structure representing that record of the dataset. The “Timestamp” and “ArticleTitle” arrays have been sorted (temporally and alphabetically, respectively) while the VisitorId and IpAddress fields have not been sorted. Note that the ArticleTitle array 450 has fewer entries than the other arrays—that is because three of the original dataset records reflected requests by clients for the same article. Through the interning process, each record is converted to a memory structure (460) comprising a list of the representative integers of the data fields that made up the record. Some embodiments may not intern all of the data fields of each record—the memory structures may contain some original data in its original form—but generally speaking, it is simpler to treat each data field identically.

The “array index” view of an embodiment highlights a difference between this technique and more general data processing methods. Specifically, it should be noted that placing data fields into fully-populated arrays, and then using the array indices to refer to the data values in in-memory structures, makes it very difficult to modify the set of data field values (i.e., to add or remove values). This is particularly true when the array is sorted. For example, once the nine data records shown in FIG. 4 have been processed and converted into memory structures, adding another record whose timestamp falls between two existing timestamps would require updating all of the memory records whose timestamp is later than the record to be added. Similarly, removing a record may leave indices unused, or require a comparable reshuffling to maintain high utilization of index values. Thus, this technique is not especially well-suited for dynamic data sets. However, for large, static, read-only datasets, embodiments provide excellent query and analysis characteristics.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that larger data sets and faster query processing can also be achieved by software and hardware that distribute the functions of embodiments of this invention differently than herein described. Such variations and implementations are understood to be captured according to the following claims.

We claim:

1. A method of preparing a plurality of multi-field data records for improved query performance, comprising:
for each record of the plurality of multi-field data records:
reading the record;
interning a value of a data field of the record to obtain an integer representing the value of the data field; and
creating a memory structure to represent the record, said memory structure containing the representative integer and excluding the value of the data field.

2. The method of claim 1, further comprising:
repeating the interning operation for at least a value of one other data field of the record to obtain a second integer representing the value of the one other data field, wherein
the memory structure contains the second integer and excludes the value of the one other data field.

3. The method of claim 1 wherein the integer representing the value of the data field is part of a densely-utilized range of integers, each representing a distinct value seen in a corresponding data field of at least one multi-field data record.

4. The method of claim 3 wherein a numerical order of integers representing distinct data values is similar to an order of the distinct data values.

5. The method of claim 4 wherein the order of the distinct data values is an alphabetical order.

6. The method of claim 4 wherein the order of the distinct data values is a numerical order.

7. The method of claim 4 wherein the order of the distinct data values is a temporal order.

8. The method of claim 4 wherein the order of the distinct data values is a revenue order.

9. The method of claim 1, further comprising:
receiving a query specification including a value for comparing with a data field;
searching an interned-value structure to find an integer representing the value for comparing with the data field; and
identifying a subset of memory structures having a corresponding value of the representative integer.

10. The method of claim 9, further comprising:
interning the subset of memory structures to obtain an integer representing said subset of memory structures.

11. A non-transitory computer-readable medium containing instructions and data to cause a programmable processor to perform operations comprising:
initializing data interning tables for a plurality of classes of data values;
processing a plurality of multi-field data records;
inserting entries in the data interning tables for each distinct value of each data class encountered during the processing operation;
constructing a memory structure to represent each multi-field data record of the plurality of multi-field data records, wherein
each memory structure includes an index of an entry in each of the data interning tables.

12. The non-transitory computer-readable medium of claim 11, containing additional data and instructions to cause the programmable processor to perform operations comprising:

13. The non-transitory computer-readable medium of claim 11, wherein distinct values in a data interning table are alphanumeric strings.

14. The non-transitory computer-readable medium of claim 11, wherein distinct values in a data interning table are timestamps.

15. The non-transitory computer-readable medium of claim 11, wherein distinct values in a data interning table are network addresses.

16. The non-transitory computer-readable medium of claim 11, wherein distinct values in a data interning table are partial Uniform Resource Names (“URNs”).

17. The non-transitory computer-readable medium of claim 11, wherein a numeric order of indices in a data interning table are similar to an alphabetical order of distinct data values inserted into the data interning table.

18. The non-transitory computer-readable medium of claim 11, wherein a numeric order of indices in a data interning table are similar to a numeric order of distinct data values inserted into the data interning table.

19. The non-transitory computer-readable medium of claim 11, wherein a numeric order of indices in a data interning table are similar to a temporal order of distinct data values inserted into the data interning table.
